(19) United States
(12) Patent Application Publication
(10) Pub. No.: US 2020/0387372 A1
(43) Pub. Date: Dec. 10, 2020

(54) MICROSERVICE FILE GENERATION SYSTEM

(71) Applicant: Dick's Sporting Goods, Inc., Coraopolis, PA (US)

(72) Inventor: Sabari Krishna Venugopal Kalavathy, Coraopolis, PA (US)

(21) Appl. No.: 16/433,306

(22) Filed: Jun. 6, 2019

(51) Int. Cl. G06F 8/77; G06F 11/36; G06F 9/54

(52) U.S. Cl. CPC G06F 8/77; G06F 9/54; G06F 11/3688

(57) ABSTRACT

A microservice file generation system provides a user interface via which the system will receive a project definition for a new or existing microservice and generate a project structure for the microservice. A user may use the project structure to develop and/or edit the configuration file(s), operational file(s) and/or other files for the microservice. When file editing is complete, the system will test the microservice's interaction with an associated application programming interface (API) to ensure that the microservice properly operates with its associated API.

### BACKGROUND

Many enterprise software applications must work with a variety of other applications, such as various browsers, operating systems and/or external services. In addition, most enterprise software applications are maintained and updated by a large, often geographically distributed team of developers rather than a single person or small group. This creates challenges for large-scale applications that are developed with a monolithic architecture, as changes to one element of the application can affect other elements in such an architecture. In addition, changes to applications developed with a monolithic architecture often can only be implemented in an update to the entire application.

To address these challenges, enterprise and other server-side applications may employ a micro services architecture, in which the application is made of a collection of loosely coupled, collaborating code sets. Each code set, as well as the service provided when the code set is running, may be referred to as a microservice. Each microservice involves a particular function, and it only needs to define operations that pertain to that function. Microservices can be stored and/or executed across multiple hosts, and therefore can help decentralize processing and memory requirements.

However, even the development of micro services requires some time and resources, both human and computational. Microservices also require that the developer know various characteristics of the application programming interfaces (APIs) with which the microservice will interact. These issues can delay the development and deployment of micro services in large enterprises.

This document describes a system that can help reduce processing time and resources required to generate or update microservices.

### SUMMARY

In various embodiments, a microservice file generation system includes a processor, a user interface, and a computer-readable medium containing programming instructions that are configured to cause the processor to create a project structure for a microservice. The system will receive a project definition for a microservice, receive definitions for domain objects for the micro service, receive dependencies between one or more of the domain objects and one or more internal or external services, and use the domain objects and the dependencies to define a project structure. The project structure includes a repository comprising various containers. Each of the containers has a label and is configured to contain code corresponding to one or more of the domain objects, one or more of the dependencies, and/or one or more additional containers. For one or more of the containers, the system will access a data store containing code elements. The system will identify a code element having one or more attributes that correspond to the label of the container. The system will extract the identified code element and populate the container by copying the code element to the container, and the system will present the project structure to a user via the user interface. The user interface is configured to, upon selection of one of the containers by the user, enable the user to edit the code element in any container that is populated with a code element, and enter code into any container that is not already populated with a code element.

Optionally, after the user has entered and/or edited one or more of the code elements, the system may access a test case file that corresponds to one or more attributes of the project, insert one or more of the entered and/or edited code elements into the test case file, and run a simulation of the test case file to test operation of the microservice. If at least one of the containers is a test container, then after running the simulation the system may save results of the simulation to the test container.

Optionally, after the user has entered and/or edited one or more of the code elements, the system may save the code elements of each of the containers to a project file.

Optionally, if one or more of the containers corresponds to a specified application program interface (API), the system may, for any container that corresponds to a specified API: access a data store of code; identify, in the data store, code that corresponds to one or more of the objects and one or more of the dependencies; and transfer the identified code from the data store to the container that corresponds to the specified API. Before transferring the identified code, the system may place the identified code in a temporary container and receive, via the user interface, edits to the identified code. If so, then when transferring the identified code from the data store to the container that corresponds to the specified API, the system may do so for the identified code with the received edits. As another option, the system may access a data store containing API documentation for various APIs, identify API documentation in the data store that corresponds to the specified API, and present the identified API documentation to the user.

Optionally, when defining the project structure, the system may create at least one of the containers as an empty container that is configured to receive user input via the user interface.

Optionally, when defining the project structure, the system may identify a project configuration file that defines the project structure names for each container in the project structure.

Optionally, one or more of the containers may include a database folder that holds domain entity and database repository classes. In addition, one or more of the containers may include an integration folder that contains classes for integration with other services.

### BRIEF DESCRIPTION OF THE DRAWINGS

FIG. 1 illustrates an example system in which one or more enterprise applications having a microservices architecture are deployed, as such a system may be known in the prior art.

FIG. 2 illustrates steps of an example domain services generation process of the prior art.

FIG. 3 is a flowchart that illustrates a microservice file generation process.

FIG. 4 illustrates an example API documentation user interface that exists the prior art.

FIG. 5 is a flowchart that examples steps of a code and build function of a file generation process.

FIG. 6 illustrates example objects for a shopping cart domain.

FIG. 7 illustrates an example set of dependencies for a shopping cart domain.

FIG. 8 illustrates an example project structure that a microservice file generation may generate using the data of FIGS. 6 and 7.

FIG. 9 illustrates an example test function.

FIG. 10 is a block diagram illustrating example components of an electronic device.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

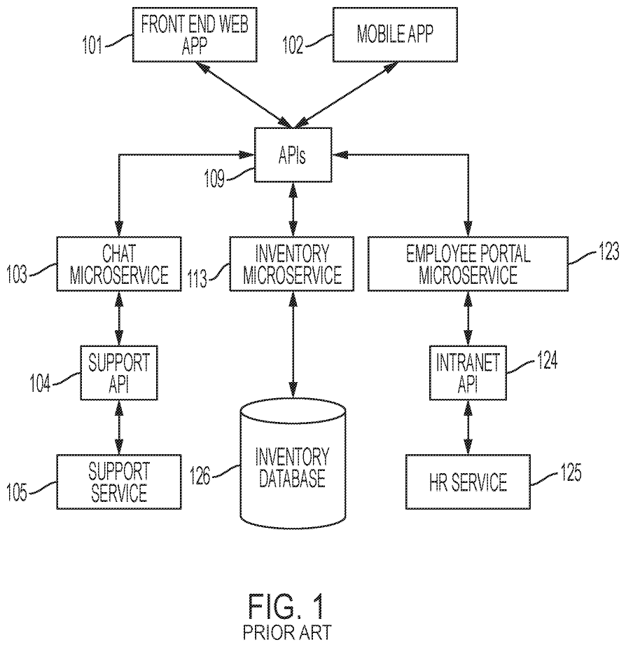

FIG. 1 illustrates an example system in which one or more enterprise applications having a microservices architecture are deployed, as such a system may exist in the prior art. In the example of FIG. 1, an online retail storefront application is available to end users via a web application 101 that may be accessed by browser software running on computing device. The storefront is also available via a mobile application 102 that is a thin client that may be installed on a user's mobile electronic device. The example of a storefront application is described here only by way of example. In fact, the systems and methods described in this document may be used for other applications, such as: customer relationship management applications; payroll, timekeeping and other human resource management applications; supply chain management applications; and other applications.

Each end-user-facing application (such as website application 101 and/or mobile application 102) will be associated with one or more application programming interfaces (APIs) 109. Each API 109 is a software intermediary that defines functions of its associated application. Each API 109 relays requests from one or more connected services to the API's associated application, and it returns the application's responses to the connected service(s). In this example, the connected services are microservices of a server-side application for managing the online storefront, including a chat microservice 103 that is connected to a technical or other customer service support service 105 via a support API 104, as well as an inventory microservice 113 that is connected to an inventory database 115. The connected services also may include microservices of a different server-side application, such as an employee access portal microservice 123 that is connected to a human resource service 125 via an employer intranet API 124.

A discussion of some background terminology will be helpful before we describe the invention. First, “domain objects” are entities and value objects that encapsulate behavior required by a domain. In the context of a retail storefront website, an example domain may include a shopping cart, a garment or shoe sizing tool, or a product comparison tool. Domain objects and sub-objects of the shopping cart domain may include features such as calculation, payment and authorization. “Domain services” encapsulate behaviors of a single domain object, and are where the business logic for a domain resides (example: create/read/update/delete information for cart domain services. In contrast to domain services, “application services” handle the flow of use cases, including any additional concerns needed on top of the domain (example: a transfer/calculate order process would be part of application services).

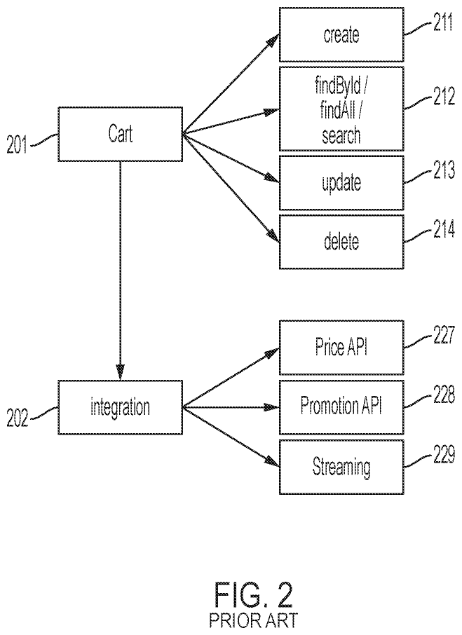

In a traditional (prior art) manual microservice generation process, developers will identify domain objects and domain sub-objects, then begin technical design of aspects such as the application programming interface (API), database, front-end and data model. When this is complete, coding and building starts, which can take several weeks. Testing and updating comes afterward, adding more time and risk of human error in the process. By way of example, referring to FIG. 2, to build a shopping cart 201 domain, the system will identify basic domain services for the cart such as create 211, read (findByID/findAll) 212, update 213 and delete 214. The services also may include a search operation. The system will then identify potential integrations 202, which are domains with which the cart 201 may collaborate or otherwise work together. Examples include a price API 227, promotion API 228, or an external ecosystem such as a streaming platform 229.

In various embodiments of the approach that the applicant has developed, a microservice file generation application is available as a set of instructions that, when executed, will cause a computing device to output a user interface via which a developer can more quickly and easily create and/or update microservices for various server-side applications. This application can increase speed, reduce coding errors, and ensure interoperability of domains and sub-domains in the code and build portion of the application generation process. The system will do this by: (1) defining the domain objects and operations; (2) defining dependencies between each domain object and internal and/or external systems; (3) defining a database/entity structure for the project; (4) starting and performing behavior-driven development; and (5) onboarding the microservice(s) to an existing platform or an under-development platform.

The microservice file generation application will generate and output on a computer system a user interface via which developers may specify features of various microservices. The system will start by receiving a project definition (step 301) from a user. In some embodiments, the user may use the microservice file generation application to generate a new microservice application file. In this case, the user may select a “define new project” or similar function in the user interface. In other embodiments, the system may enable the developer to select and edit an existing microservice application file. The application may do this by providing a user-selectable function for generating new files, or by defining the project as an existing microservice, in which case the system will access and retrieve existing files that are available in a connected library of microservice application files. The files associated with any particular microservice will typically be stored together in a data store that contains a directory for the microservice, and they may include configuration (config) files, a project object model (POM), source code for execution of the microservice's functions, and other fields.

The system will then open the defined project (step 302) as one or more build files, which may be a new file for a new microservice or an existing file (or files) for an existing microservice. The system may use a toolkit such as Maven (available at maven.apache.org) to open and enable a user to access and edit the microservice's files (step 303).

The system will provide a user interface via which a user may select and edit the microservice's operational file (i.e., the file with rules for generating requests for a connected API and receiving and processing responses from the API), configuration files containing parameters and settings that the operational file, object files containing constants and/or other information such as source and sink identifiers. Optionally, the system may open one or more templates, and/or apply certain structures, to build any of these files and/or edit a known file.

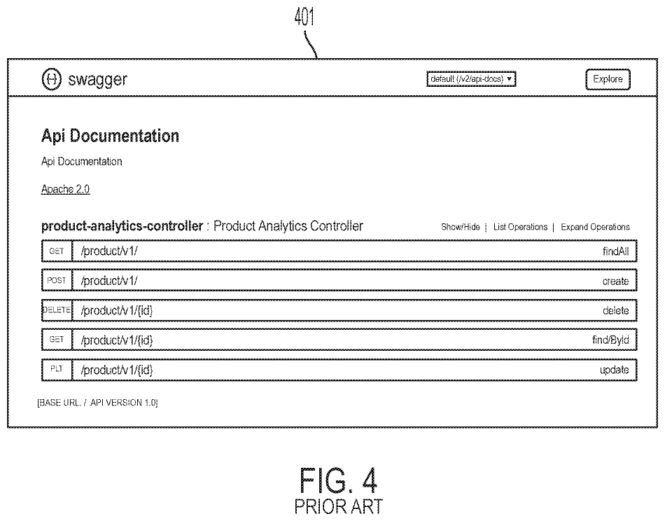

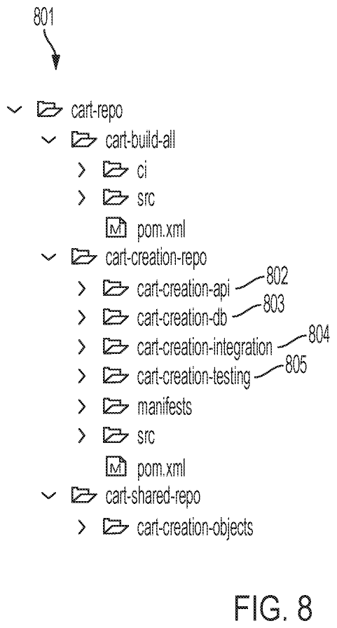

Optionally, the system may include a user interface via which the user may access documentation for the API (step 304) to which the microservice will be linked. This may be a unique user interface, or a known interface such as the Swagger UI 401, as shown in FIG. 4. The system may access the documentation by accessing a data store that includes API documentation for multiple APIs, selecting API documentation for an API for which a code element is included in a project container (discussed below in the context of FIG. 8), and presenting the selected API documentation to the user.

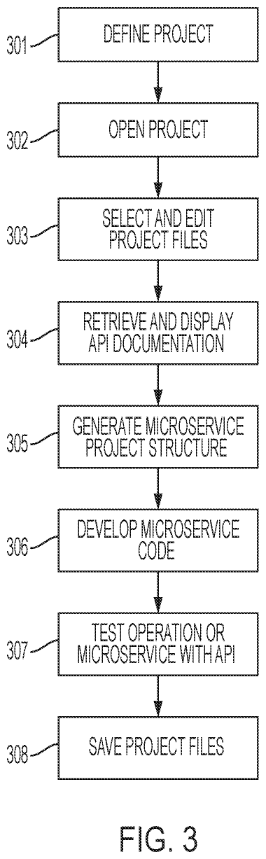

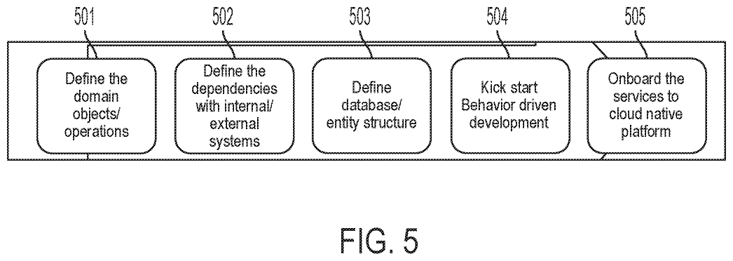

Returning to FIG. 3, when the user has completed entering or specifying information, the system will then generate the microservice structure 305 which serves as a tool via which the development team may develop the microservice itself. Referring to FIG. 5, the system will do this by: defining the domain objects and operations (step 501); (2) defining dependencies between each domain object and internal and/or external systems (step 502); (3) defining a database/entity structure (step 503); (4) starting and performing behavior-driven development (step 504); and (5) onboarding the microservice(s) to an existing platform or a platform that is under development (step 505).

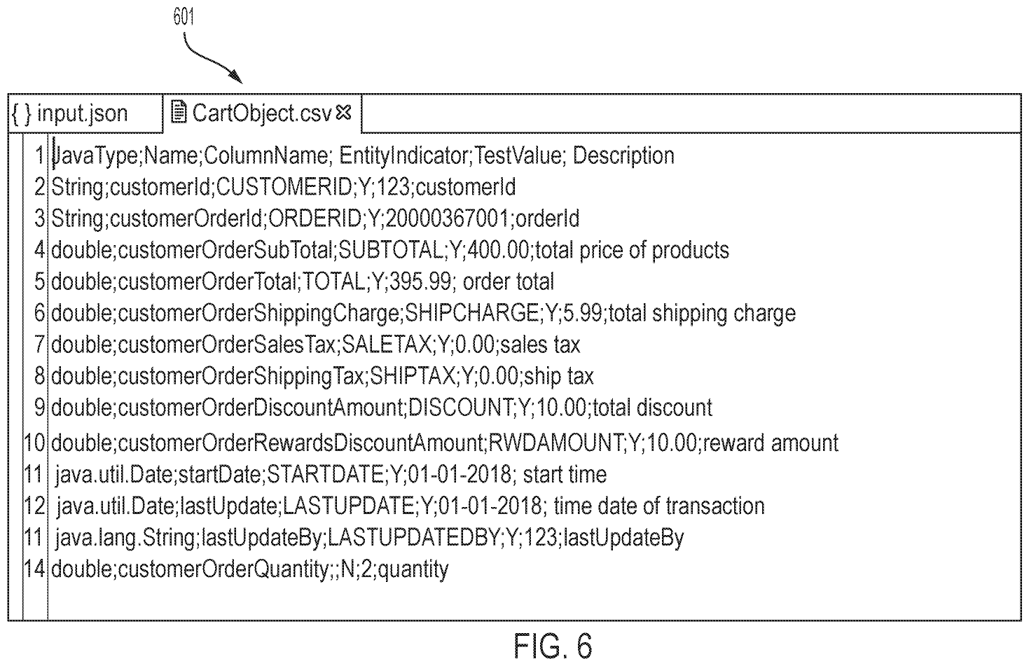

The system may define the domain objects (step 501) and operations by a combination of manual input via a user interface, retrieval from a database or lookup table, or otherwise. For example, FIG. 6 illustrates an example set of objects 601 for a shopping cart domain. The objects 601 of this example include customerID, orderID, price_of_products, order_total, total_shipping_charge, sales_tax, and others.

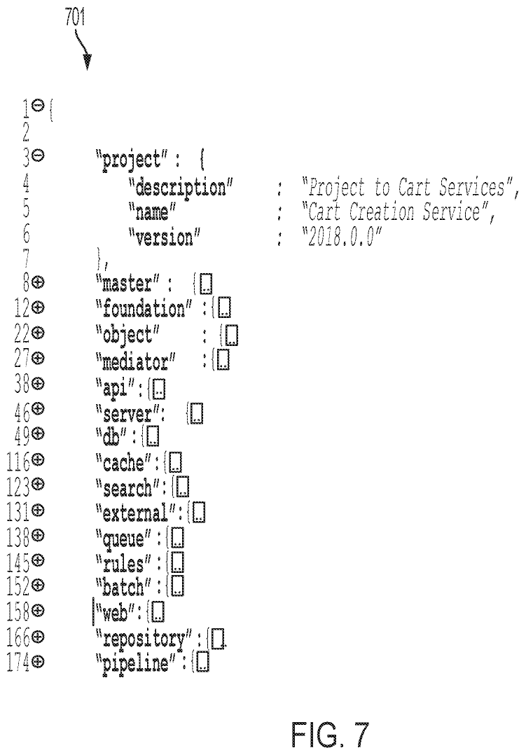

The system may define the dependencies (step 502) between each domain object by a combination of manual input via a user interface, retrieval from a database or lookup table, or otherwise. For example, FIG. 7 illustrates an example set of dependencies 701 for a shopping cart domain. The dependencies include API, DB (database), search and others.

The system will then use the objects and dependencies to automatically create a project structure (step 503) that code developers can use to expedite a code generation process. For example, FIG. 8 illustrates a project structure 801 that includes a set of repositories, each of which is a higher-level container for one or more subcontainers (in this case folders and subfolders) that hold code elements of a shopping cart function (cart-repo) using the data from FIGS. 6 and 7. The system will create the project structure by retrieving a project configuration file that defines the general structure and names for each container in that structure. The configuration file may be located based on a known assigned name (such as config.json), and it may contain rules and/or data for defining containers within the project.

Each container in a repository will have sub-containers and/or one or more files corresponding to its container label. The system may populate any or all of the containers in the repository with certain default information. For example, an API folder (container) 802 may include code for security, manifest, swagger and basic create-read-update-delete (CRUD) services. A database folder 803 may hold domain entity and database repository classes. An integration folder 804 may contain classes used for connecting with other services. The integration folder 804 also may contain a sample client program to test the integration. A testing folder 805 may be used to hold artifacts from prior integration tests and/or new tests, when performed. Other folders such as a messaging folder may be generated if the system determines that the objects and dependencies would support a messaging function.

Some of the containers may be empty and available for user input. The system may populate any or all of the other containers by accessing a data store of code, identifying code in the data store that has a label corresponding to the label of the container, and extracting the identified code to place a copy of the code in the container. A code may correspond to the label if it matches the label, if it has a semantic similarity to the label, if it corresponds to both the container's label and the container's parent container's label, or based on any suitable a set of rules that the system employs.

Optionally, the system may process and modify the code before copying it to a container. For example, before being deployed to a container, the system may place a code set for a container in a temporary output folder. The code in the output folder may have one or more fields that will be completed and/or revised to include certain attributes of the project, such as a project label and/or one or more dependencies. When a developer has reviewed, revised (if needed) and accepted the code in the output folder, the code may then be transferred (moved or copied) to the appropriate container.

Returning to FIG. 3, when the project structure is complete, the development team may use the project structure to develop the code for the microservice (step 306). Developers may do this by writing the code to some or all folders in the structure. In addition or alternatively, the system may include a data store with a code library for various predefined folders. The system may include a search function by which developers may select and populate project folders with code from the library. Alternatively or in addition, the system may use metadata to associate code in the library with various functions, objects and dependencies and, and it may automatically populate project folders that relate to those functions, objects or dependencies with corresponding code from the library. The developers can then accept the code from the library, or modify it to meet specific project requirements. This can help save development time, ensure consistency in code sets across microservices, and reduce errors caused by generating new code each time.

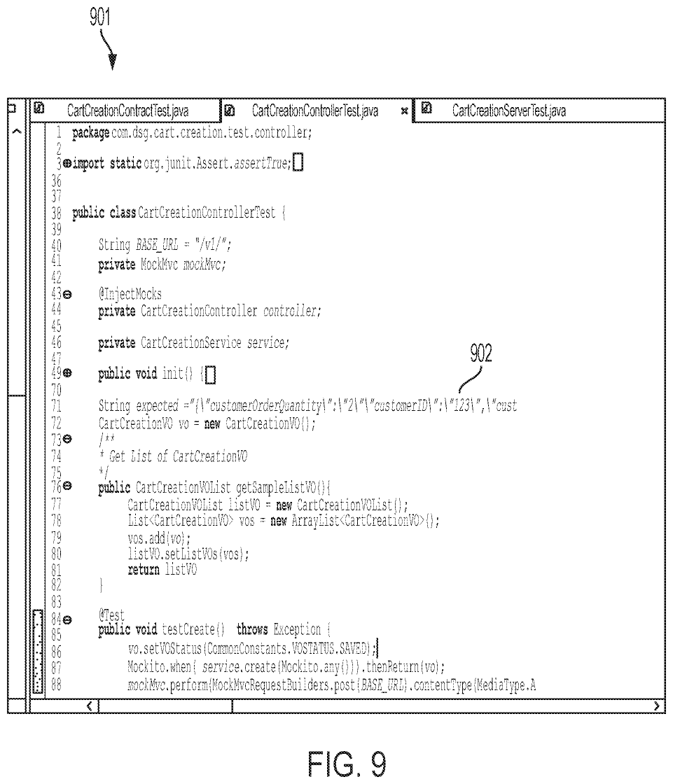

In some embodiments, the system may automatically test (step 306) a new or updated microservice application file set to ensure that it works with the associated API. The system will do this by running test case files, an example of which 901 is shown in FIG. 9. A test case file may be selected by a user, or it may automatically run from a test case file library, with the system selecting a test having attributes that correspond to the project. Various objects (e.g., 902) may be inserted into corresponding object insert locations of the test file and run in a simulated manner to ensure proper operation.

When editing and/or testing of the microservice's files has completed, the system will save the new and/or updated files to the data store in the microservice's directory (step 308), such as in a testing container 805 as shown in FIG. 8.

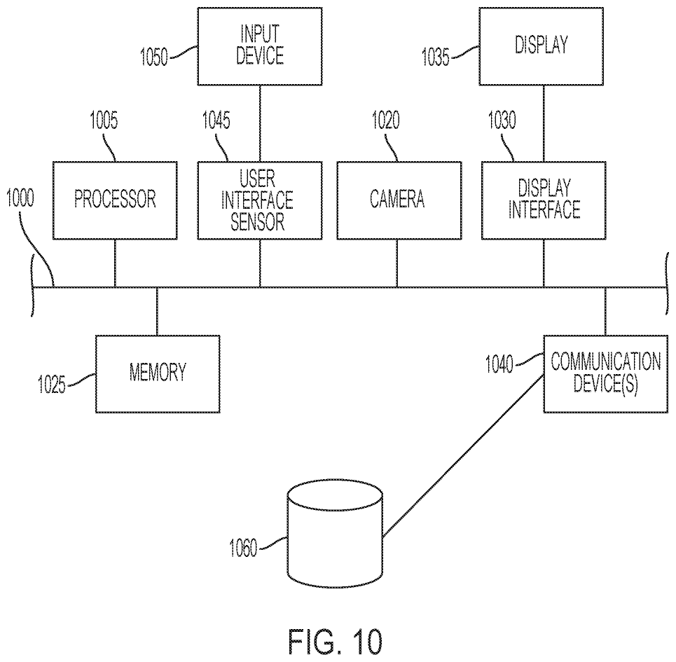

FIG. 10 depicts an example of internal hardware that may be used to execute the programming instructions and provide the user interfaces described in this document. An electrical bus 1000 serves as an information highway interconnecting the other illustrated components of the hardware. Processor 1005 is a central processing device of the system, configured to perform calculations and logic operations required to execute programming instructions. Read only memory (ROM), random access memory (RAM), flash memory, hard drives and other devices capable of storing electronic data constitute examples of memory devices 1025.

An optional display interface 1030 may permit information from the bus 1000 to be displayed on a display device 1035 in visual, graphic or alphanumeric format. An audio interface and audio output (such as a speaker) also may be provided. Communication with external devices may occur using various communication devices 1040 such as a wireless antenna, an RFID tag and/or short-range or near-field communication transceiver, each of which may optionally communicatively connect with other components of the device via one or more communication system. The communication device 1040 may be configured to be communicatively connected to a communications network, such as the Internet, a local area network or a cellular telephone data network.

The hardware may also include a user interface sensor 1045 that allows for receipt of data from input devices 1050 such as a keyboard, a mouse, a joystick, a touchscreen, a touch pad, a remote control, a pointing device and/or microphone. Digital image frames also may be received from a camera 1020 that can capture video and/or still images.

The system also may include a data store 1060 that includes a computer-readable, non-transitory memory for storing information. Such information may include, for example, API documentation and/or the default code sets that the system may use to populate containers of a project structure.

In the description above, the terms “electronic device” or a “computing device” refers to a device or system that includes a processor and memory, and other components such as those shown in FIG. 10. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, tablet computers, laptop computers, media players and the like. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” or “electronic device” for brevity.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

In this document, the term “connected” when used to describe a relationship between two services or applications, means that the services or application are communicatively connected via one or more wired or wireless communication paths.

The features and functions described above, as well as alternatives, may be combined into many other different systems or applications. Various alternatives, modifications, variations or improvements may be made by those skilled in the art, each of which is also intended to be encompassed by the disclosed embodiments.

1. A method of generating a set of microservice files, comprising, by a microservice file generation system:
causing a computing device to output a project definition user interface via which the system will receive a project definition for a microservice from a user;
receiving definitions for a plurality of domain objects for the microservice;
receiving a plurality of dependencies between one or more of the domain objects and one or more internal or external services;
using the domain objects and the dependencies to define a project structure, wherein:
the project structure comprises a repository comprising plurality of containers, and
each of the containers has a label and is configured to contain code corresponding to one or more the following: one or more of the domain objects, one or more of the dependencies, or one or more additional containers;
for one or more of the containers:
accessing a data store containing a plurality of code elements,
identifying a code element having one or more attributes that correspond to the label of the container, and
extracting the identified code element and populating the container by copying the code element to the container; and
presenting the project structure to a user via a user interface that is configured to, upon selection of one of the containers by the user, enable the user to:
for any container that is populated with a code element, edit the code element in that container, and
enter code into any container that is not already populated with a code element.

2. The method of claim 1, further comprising, after the user has entered and/or edited one or more of the code elements:
accessing a test case file that corresponds to one or more attributes of the project;
inserting one or more of the entered and/or edited code elements into the test case file; and
running a simulation of the test case file to test operation of the micro service.

3. The method of claim 2, wherein:
at least one of the containers is a test container; and
the method further comprises, after running the simulation, saving results of the simulation to the test container.

4. The method of claim 1, further comprising, after the user has entered and/or edited one or more of the code elements, saving the code elements of each of the containers to a project file.

5. The method of claim 1, wherein:
one or of the more containers corresponds to a specified application program interface (API);
for any container that corresponds to a specified API, the method further includes:
accessing a data store of code,
identifying, in the data store, code that corresponds to one or more of the objects and one or more of the dependencies, and
transferring the identified code from the data store to the container that corresponds to the specified API.

6. The method of claim 5, further comprising:
before transferring the identified code:
placing the identified code in a temporary container, and
receiving, via the user interface, edits to the identified code; and
when transferring the identified code from the data store to the container that corresponds to the specified API, doing so for the identified code with the received edits.

7. The method of claim 5, further comprising:
accessing a data store containing API documentation for a plurality of APIs and identifying API documentation in the data store that corresponds to the specified API; and
presenting the identified API documentation to the user.

8. The method of claim 1, wherein using the domain objects and the dependencies to define the project structure comprises creating at least one of the containers as an empty container that is configured to receive user input via the user interface.

9. The method of claim 1, wherein using the domain objects and the dependencies to define the project structure comprises identifying a project configuration file that defines the project structure names for each container in the project structure.

10. The method of claim 1, wherein:
one or more of the containers comprises a database folder that holds domain entity and database repository classes; and
one or more of the containers comprises an integration folder that contains classes for integration with other services.

11. A microservice file generation system, comprising:
a processor,
a user interface; and
a computer-readable medium containing programming instructions that are configured to cause the processor to:
receive a project definition for a microservice,
receive definitions for a plurality of domain objects for the micro service,
receive a plurality of dependencies between one or more of the domain objects and one or more internal or external services, and
use the domain objects and the dependencies to define a project structure, wherein:
the project structure comprises a repository comprising plurality of containers; and
each of the containers has a label and is configured to contain code corresponding to one or more the following: one or more of the domain objects, one or more of the dependencies, or one or more additional containers, for one or more of the containers:
access a data store containing a plurality of code elements;
identify a code element having one or more attributes that correspond to the label of the container; and
extract the identified code element and populate the container by copying the code element to the container, and
present the project structure to a user via the user interface;
wherein the user interface is configured to, upon selection of one of the containers by the user, enable the user to:
for any container that is populated with a code element, edit the code element in that container, and
enter code into any container that is not already populated with a code element.

12. The system of claim 11, further comprising additional programming instructions that are configured to cause the processor to, after the user has entered and/or edited one or more of the code elements:
access a test case file that corresponds to one or more attributes of the project;
insert one or more of the entered and/or edited code elements into the test case file; and
run a simulation of the test case file to test operation of the micro service.

13. The system of claim 12, wherein:
at least one of the containers is a test container; and
the system comprises additional programming instructions that are configured to cause the processor to, after running the simulation, save results of the simulation to the test container.

14. The system of claim 11, further comprising additional programming instructions that are configured to cause the processor to, after the user has entered and/or edited one or more of the code elements, save the code elements of each of the containers to a project file.

15. The system of claim 11, wherein:
one or of the more containers corresponds to a specified application program interface (API);
the system comprises additional programming instructions that are configured to cause the processor to, for any container that corresponds to a specified API:
access a data store of code,
identify, in the data store, code that corresponds to one or more of the objects and one or more of the dependencies, and
transfer the identified code from the data store to the container that corresponds to the specified API.

16. The system of claim 15, further comprising additional programming instructions that are configured to cause the processor to:
before transferring the identified code:
place the identified code in a temporary container, and
receive, via the user interface, edits to the identified code; and
when transferring the identified code from the data store to the container that corresponds to the specified API, doing so for the identified code with the received edits.

17. The system of claim 15, further comprising additional programming instructions that are configured to cause the processor to:
access a data store containing API documentation for a plurality of APIs and identifying API documentation in the data store that corresponds to the specified API; and
present the identified API documentation to the user.

18. The system of claim 17, wherein the programming instructions to use the domain objects and the dependencies to define the project structure comprise instructions to create at least one of the containers as an empty container that is configured to receive user input via the user interface.

19. The system of claim 11, wherein the programming instructions to use the domain objects and the dependencies to define the project structure comprise instructions to identify a project configuration file that defines the project structure names for each container in the project structure.

20. The system of claim 11, wherein:
one or more of the containers comprises a database folder that holds domain entity and database repository classes; and
one or more of the containers comprises an integration folder that contains classes for integration with other services.
